(19) United States
(12) Patent Application Publication
(10) Pub. No.: US 2011/0197459 A1
(43) Pub. Date: Aug. 18, 2011

(54) SHAVING AIDS

(76) Inventor: Shelly Starling, Lansdale, PA (US)

(21) Appl. No.: 13/027,858

(22) Filed: Feb. 15, 2011

Related U.S. Application Data
(60) Provisional application No. 61/304,641, filed on Feb. 15, 2010.

(51) Int. Cl. B26B 21/40; B05D 1/36

(52) U.S. Cl. 30/538; 427/407.1

(57) ABSTRACT

A shaving aid includes a substrate and a lubricating layer. Particles in the lubricating layer may be PEO, engineered particles, encapsulated liquid and/or particles, minerals, or other conventional particles or substances.

### CROSS-REFERENCE TO RELATED APPLICATIONS

This claims the benefit of U.S. Patent Application Ser. No. 61/304,641, filed Feb. 15, 2010, the disclosure of which is hereby incorporated by reference as if set forth in its entirety herein.

### BACKGROUND

This invention relates to shaving devices, and more particularly to lubricating shaving aids for razors.

Conventional safety razors often include one or more blades in a fixed or pivoting cartridge. Many conventional cartridges include a shaving aid strip of other structure that includes shaving aid agents for a wide variety of purposes. For example, conventional shaving aid components include lubricating agents, drag reducing agents, depilatory agents, cleaning agents, and medicinal agents.

Many conventional shaving aid strips have a solid, non-porous film or substrate having a lubricating aid located on its exposed surface or as part of the substrate matrix. For example, a known shaving aid strip includes a water-soluble polymeric component, such as polyethylene oxide (PEO), in a water-insoluble polymeric matrix, such as, polystyrene. When exposed to water and drawn across skin, the PEO leaches from the polystyrene matrix onto the skin. The interface between the skin and blades is lubricated by the lubricating properties of PEO in the presence of water. The lubricating properties of the shaving aid strip degrades, however, over time with the depletion or inaccessibility of remaining PEO.

United States Patent Application Publication 2008/0216321, entitled “Shaving Aid Delivery System For Use with Wet Shave Razors,” discloses a hydrophilic foam pad having shaving aid material incorporated in a foam, especially a nanofoam. Pathways formed in the foam expel the shaving aid, such as PEO, when solubilized and released.

United States Patent Application Publication 2009/0212454, entitled “Process For Making Integrated Layered Urethane Products,” discloses a process for making polyurethane foam shapes having an internal core layer of a water soluble polymer, such as PEO.

U.S. Pat. No. 4,291,463, entitled Water-Soluble Shaving Aid for Razor Blades, discloses a PEO coating over a layer of polytetrafluoroethylene, which is located on a razor blade. Each of the patents and the patent publication mentioned above are incorporated by reference.

There is a need for improved shaving aids having lubricating properties and other beneficial functions.

### SUMMARY

Shaving aids for a razor include a lubricating layer located on or over a substrate. The lubricating layer may be applied directly to the substrate or be separated from the substrate by one or more intermediate layers.

A shaving aid system for attachment to a razor comprises: a substrate; at least one shaving aid composition disposed in the substrate and capable of transmission upwardly within the substrate; and a lubricating layer located over the substrate. The lubricating layer is formed of material comprising a polyol, such that the shaving aid composition is capable of passing through the lubricating layer.

Preferably, the polyol is a polymeric polyol such as polyethylene glycol, polypropylene glycol, poly (tetramethylene ether) glycol, polyethylene oxide, polypropylene oxide, a reaction product of glycerin and propylene oxide, ethylene oxide, or a combination thereof, a reaction product of a diol and a dicarboxylic acid or its derivative, a natural oil polyol; or any combination thereof. Also, the polyol may be a polymeric polyol selected from the group consisting of a reaction product of a diol and a dicarboxylic acid or its derivative, polyethylene glycol, polypropylene glycol, polyethylene oxide, polypropylene oxide, or a reaction product of glycerin and propylene oxide or ethylene oxide; or may be a selected from the group consisting of 1,2-propanediol, 1,4-propanediol, ethylene glycol, glycerin, pentaerythritol, malitol, sorbitol, isomalt, or any combination thereof; or any combination thereof.

The polyol may also be a monomeric polyol, such as 1,2-propanediol, 1,4-propanediol, ethylene glycol, glycerin, pentaerythritol, malitol, sorbitol, isomalt, or any combination thereof; or any combination thereof.

The layer is formed of particles and/or may be formed by applying as a liquid. The substrate may be a foam such that the lubricating layer is in contact with an upper surface of the foam. The lubricating layer may be a continuous, non-woven layer, and wherein the shaving aid composition is permeable through the lubricating layer. The lubricating layer may be formed of solid PEO. The lubricating layer may be continuous or discontinuous. The lubricating layer may be a woven fabric.

The foam substrate may be compressible in response to application of the razor to a user's skin, and may include internal pores for housing the shaving aid composition. The foam may include pathways for delivery of the shaving aid composition upwardly toward the lubricating layer. The shaving aid composition may be at least one of a biocide, a fragrance, a vitamin, an antimicrobial, minerals, and a soap.

The shaving aid may include solid particles located in the lubricating layer or the substrate or both, and/or may include nano-diamond located in the lubricating layer or the substrate or both.

A method of forming a shaving aid comprising the steps of providing a substrate and applying a lubricating layer, as described herein is also contemplated.

### BRIEF DESCRIPTION OF THE FIGURES

FIG. 1 is a schematic, cross-sectional view of an embodiment of the present invention illustrating particles within an adhesive layer;

FIG. 2 is a schematic, cross-sectional view of a second embodiment of the present invention illustrating particles on an adhesive layer and including a top coat;

FIG. 3 is a schematic, cross-sectional view of a third embodiment of the present invention illustrating exposed particles that are adhered to a substrate;

FIG. 4 is a schematic, cross-sectional view of a fourth embodiment of the present invention illustrating exposed particles adhered to a foam;

FIG. 5 is a schematic, cross-sectional view of a fifth embodiment of the present invention illustrating exposed particles adhered to a foam and including PEO or other particles located within the foam; and

FIG. 6 is a schematic illustration of a method of forming a sixth embodiment of the present invention and a cross-sectional view of the sixth embodiment, illustrating a layer applied to a substrate as a liquid.

### DETAILED DESCRIPTION OF PREFERRED EMBODIMENTS

A shaving aid system 10 for attachment to a razor (not shown in the figures) includes a substrate and a lubricating layer disposed on or in the substrate. The substrate may be a conventional substrate, such as a polymer strip, for example a urethane strip, that may be impregnated or otherwise contain beneficial shaving aid agents. The strip may be as described in United States Patent Application Publication 2009/0212454 or other conventional strips. The substrate also may be a foam, such as described in United States Patent Publication 2008/0216321 or other conventional foams. Also, the substrate may be a non-woven material or a woven fabric.

The substrate may act as a carrier to the layer or the particles, or may also itself contain shaving aids that are capable of transmission upwardly within the substrate. The shaving aid agents encompasses lubricants, biocides, fragrances, vitamins, antimicrobials, soaps and other beneficial agents. To make the shaving aid agents in the substrate accessible or able to be delivered, the lubricating layer may discontinuous or permeable to the shaving aid so that the shaving aid can migrate through the lubricating layer. For merely one specific example, a substrate of woven fabric may be soaked or otherwise impregnated with a biocide or other agent. Also, the underlying substrate or foam may be compressible to pump the shaving aid upwardly to or through the lubricating layer. Where a foam is used as the substrate, pores or passages in the foam may facilitate transfer of the shaving aid to or through the foam, as described in United States Patent Publication 2008/0216321.

As shown in the figures, lubricating material is located on or over the substrate 12 and may include a lubricating agent and an adhesive. The layer may be applied as a liquid onto a substrate or as particles, preferably including PEO, applied to the substrate by any means, such as sprinkle coating.

FIG. 1 illustrates the particles within an adhesive layer that binds the particles to the substrate. The adhesive may be configured to wear away or be friable upon application of the razor to skin, may be permeable to the particles or the products of the particles in water, or may be configured such that the particles can dissolve or leach from the adhesive. The adhesive shown in FIG. 1 preferably is a resin of acrylic, latex, polyester, or other type, or other known adhesive. The adhesive may have function in addition to the functions explained in this description.

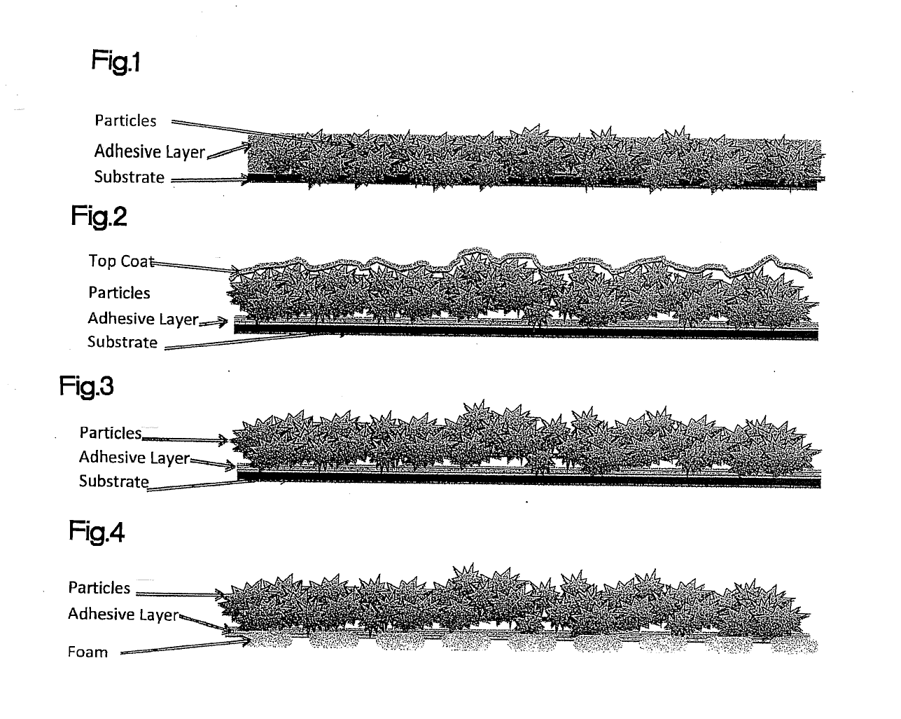

The particles of illustrated in FIG. 2 are embedded in an adhesive layer or embedded in the substrate and held by the adhesive layer. A thin top coat of the adhesive or other known material is applied. The top coat may be permeable to the particles or shaving aids in the substrate or discontinuous.

FIG. 3 illustrates particles that are embedded in the adhesive on the substrate or embedded in the substrate and held in place by the adhesive. The particles in the embodiment of FIG. 3 are exposed.

FIG. 4 illustrates the particles embedded in an adhesive on a foam or embedded in the foam and held by the adhesive. The present invention encompasses any foam, including conventional nanofoam. delivery system may be used has a frame that defines a skin-contacting surface, at least one razor blade located in the frame, and the shaving aid delivery system coupled to the skin-contacting surface. A shaving implement having a handle and a razor cartridge attached thereto has the shaving aid delivery system attached to the razor cartridge.

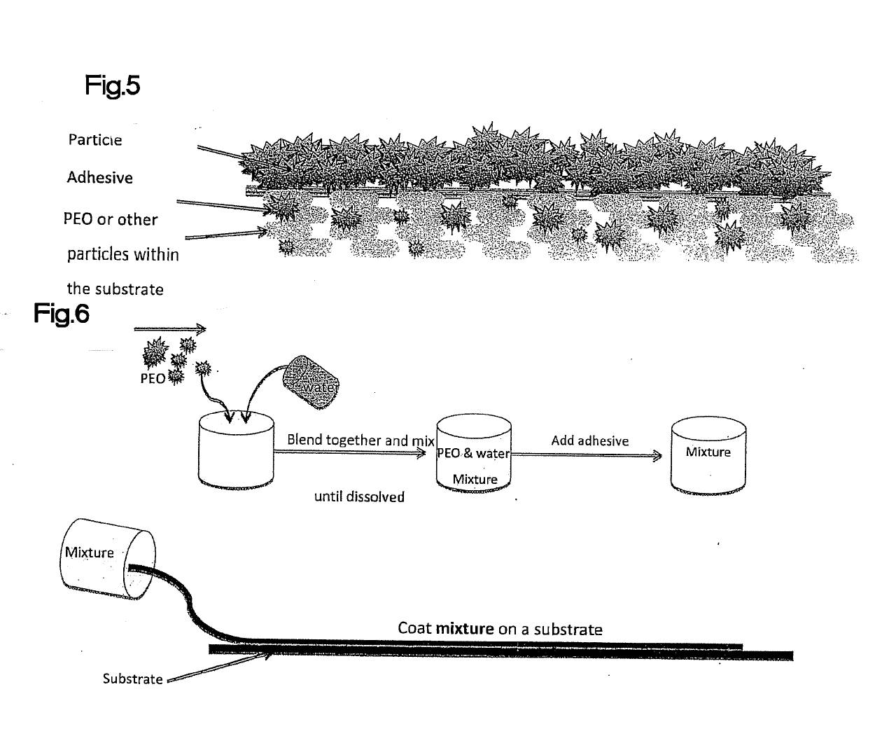

FIG. 5 illustrates particles and substrate as described with respect to FIG. 4, and with additional particles located in the foam substrate. The particles in the substrate may be any of the particles described in this disclosure. Also, the foam may be impregnated with shaving aid agents that are not particles.

FIG. 6 illustrates a method of applying a lubricating layer over a substrate that does not include particles. A liquid is first prepared. In the example of FIG. 6, a PEO is blended with a solvent and mixed until dissolved, then an adhesive is added. The mixture is applied to the substrate by flowing, spraying, or other known methods onto the substrate. According, the present invention is not limited to the use of particles in the lubricating layer. PEO applied by specific process to a solid, continuous substrate is illustrated in FIG. 6, but application of a liquid layer according to the present invention is not so limited. Rather, the methods and product encompasses any shaving agent layer formed in a liquid in any composition and by any means, and applied by any means.

In any of the embodiments shown, the adhesive may be any conventional adhesive, as will be understood by persons familiar with shaving aid technology.

The particles shown in the figures may be conventional PEO particles, such as those commercially available under the trade name POLYOX. The present invention is not limited to PEO particles, but rather the inventors surmise that the present invention will achieve the goal of aiding shaving by employing a layer or particles of a polymeric polyol selected from the group consisting of polyethylene glycol, polypropylene glycol, poly (tetramethylene ether) glycol, polyethylene oxide, polypropylene oxide, a reaction product of glycerin and propylene oxide, ethylene oxide, or a combination thereof, a reaction product of a diol and a dicarboxylic acid or its derivative, a natural oil polyol; or any combination thereof. Also, the layer or particles may be a polymeric polyol selected from the group consisting of a reaction product of a diol and a dicarboxylic acid or its derivative, polyethylene glycol, polypropylene glycol, polyethylene oxide, polypropylene oxide, or a reaction product of glycerin and propylene oxide or ethylene oxide; or may be a selected from the group consisting of 1,2-propanediol, 1,4-propanediol, ethylene glycol, glycerin, pentaerythritol, malitol, sorbitol, isomalt, or any combination thereof; or any combination thereof. The layer or particles may also be a monomeric polyol selected from the group consisting of 1,2-propanediol, 1,4-propanediol, ethylene glycol, glycerin, pentaerythritol, malitol, sorbitol, isomalt, or any combination thereof; or any combination thereof.

Also, the particles may be an engineered particle that combines several beneficial agents or properties. For example, the present invention encompasses lubricating, biocide, fragrance, and other conventional or specifically configured agents. Further, the above description describes a lubricating layer and lubricating particles, but the present invention encompasses layers and/or particles having additional or different properties of known shaving aid agents.

The lubricating layer and substrate, in addition to the polyols described herein, may include particles, preferably having a hardness of between 1 and 10 on the mohs scale, such as cerium oxide, aluminum oxide, silicon oxide, zirconium oxide, silicon carbide, titanium carbide, titanium nitride, silicon nitride boron nitride, diamond, nanodiamond, non-diamond nanoparticles, and combinations thereof. The inventors surmise that nanodiamond might be especially useful because of nanodiamonds lubricating properties. Also, the particles may be non-metallic, inorganic solids such as carbides, oxides, nitrides and certain carbonaceous materials. Oxides include silicon oxide (such as quartz, cristobalite and glassy forms), cerium oxide, zirconium oxide, aluminum oxide. Carbides and nitrides include, but are not limited to, silicon carbide, aluminum, boron nitride (including cubic boron nitride), titanium carbide, titanium nitride, silicon nitride. Carbonaceous materials include diamond, which broadly includes synthetic diamond, diamond-like carbon, and related carbonaceous materials such as fullerite and aggregate diamond nanorods. Materials may also include a wide range of naturally occurring mined minerals, such as garnet, cristobalite, quartz, corundum, feldspar, talc, and pumice by way of example.

Also, the particles may be encapsulated by conventional means such that the capsules are mechanically broken or dissolved in water to release particles contained in the capsules. The term particles also encompasses liquids that are encapsulated.

The substrate or foam is attached to the razor cartridge such that during a shaving operation, the foam is squeezed against the user's skin and the shaving aid material is dispelled from the foam. The shaving aid material preferably is a water soluble composition that may be impregnated into the foam.

The present invention also encompasses a razor cartridge having the shaving aid system described in this disclosure.

1. A shaving aid system for attachment to a razor comprising:
a substrate;
at least one shaving aid composition disposed in the substrate and capable of transmission upwardly within the substrate;
a lubricating layer located over the substrate, the lubricating layer formed of material comprising a polyol, such that the shaving aid composition is capable of passing through the lubricating layer.

2. The shaving aid of claim 1 wherein the polyol is a polymeric polyol.

3. The shaving aid of claim 1 wherein the polyol is a polymeric polyol selected from the group consisting of polyethylene glycol, polypropylene glycol, poly (tetramethylene ether) glycol, polyethylene oxide, polypropylene oxide, a reaction product of glycerin and propylene oxide, ethylene oxide, or a combination thereof, a reaction product of a diol and a dicarboxylic acid or its derivative, a natural oil polyol; or any combination thereof, or wherein the polyol is a polymeric polyol selected from the group consisting of a reaction product of a diol and a dicarboxylic acid or its derivative, polyethylene glycol, polypropylene glycol, polyethylene oxide, polypropylene oxide, or a reaction product of glycerin and propylene oxide or ethylene oxide; or may be a selected from the group consisting of 1,2-propanediol, 1,4-propanediol, ethylene glycol, glycerin, pentaerythritol, malitol, sorbitol, isomalt, or any combination thereof; or any combination thereof.

4. The shaving aid of claim 1 wherein the polyol is a monomeric polyol.

5. The shaving aid of claim 1 wherein the polyol is a monomeric polyol selected from the group consisting of 1,2-propanediol, 1,4-propanediol, ethylene glycol, glycerin, pentaerythritol, malitol, sorbitol, isomalt, or any combination thereof; or any combination thereof.

6. The shaving aid of claim 1 wherein the lubricating layer is formed of particles.

7. The shaving aid of claim 1 wherein the lubricating layer is formed by applying as a liquid.

8. The shaving aid system of claim 1 wherein the substrate is a foam.

9. The shaving aid system of claim 8 wherein the lubricating layer is in contact with an upper surface of the foam.

10. The shaving aid system of claim 8 wherein the lubricating layer is a continuous, non-woven layer, and wherein the shaving aid composition is permeable through the lubricating layer.

11. The shaving aid system of claim 10 wherein the lubricating layer is formed of solid PEO.

12. The shaving aid system of claim 8 wherein the lubricating layer is discontinuous.

13. The shaving aid system of claim 12 wherein the lubricating layer is a woven fabric.

14. The shaving aid system of claim 8 wherein the foam substrate is compressible in response to application of the razor to a user's skin.

15. The shaving aid system of claim 8 wherein the foam includes internal pores for housing the shaving aid composition.

16. The shaving aid system of claim 8 wherein the foam includes pathways for delivery of the shaving aid composition upwardly toward the lubricating layer.

17. The shaving aid system of claim 8 wherein shaving aid composition is at least one of a biocide, a fragrance, a vitamin, an antimicrobial, minerals, and a soap.

18. The shaving aid of claim 1 further comprising solid particles located in the lubricating layer or the substrate or both.

19. The shaving aid claim 1 further comprising nano-diamond located in the lubricating layer or the substrate or both.

20. A method of forming a shaving aid comprising the steps of:
Providing a substrate;
Disposing at least one shaving aid composition in the substrate, the shaving aid composition being capable of transmission upwardly within the substrate; and
Disposing a lubricating layer over the substrate, the lubricating layer being formed of material comprising a polyol, such that the shaving aid composition is capable of passing through the lubricating layer.
